(19) United States
(12) Patent Application Publication
(10) Pub. No.: US 2025/0309741 A1
(43) Pub. Date: Oct. 2, 2025

(54) METHOD FOR MANUFACTURING MOTOR AND METHOD FOR JOINING MOTOR

(71) Applicant: NIDEC PRECISION CORPORATION, Tokyo (JP)

(72) Inventor: Yuki SHODA, Tokyo (JP)

(21) Appl. No.: 19/093,250

(22) Filed: Mar. 28, 2025

(30) Foreign Application Priority Data
Apr. 1, 2024 (JP) 2024-059211

(51) Int. Cl. H02K 15/90

(52) U.S. Cl. CPC H02K 15/90

(57) ABSTRACT

A method is for manufacturing a brushless motor including a magnet surrounding a rotational shaft, a cylindrical coil including wires being wound, and a motor case accommodating the magnet and the coil. The coil has multiple phases. The wires each corresponding to one of the phases are shifted from one another in a rotation direction of the rotational shaft. The wires include a first wire for a first phase and a second wire for a second phase adjacent to the first phase in the rotation direction. The first wire is colored differently from the second wire. The coil has a color boundary between the wires for the first and second phases adjacent to each other in the rotation direction. The color boundary is aligned with a mark in the motor case to fix the coil to the motor case.

### RELATED APPLICATIONS

The present application claims priority to Japanese Application Number 2024-059211, filed Apr. 1, 2024, the disclosure of which is hereby incorporated by reference herein in its entirety.

### BACKGROUND

### Technical Field

The present invention relates to a method for manufacturing a motor and a method for joining a motor.

### Description of the Background

A brushless motor including Hall-effect integrated circuits (Hall ICs) detects the position of the rotor to timely feed a current to the coil.

For example, Patent Literature 1 describes such a brushless motor including Hall ICs axially facing the rotor and radially aligned with first and second tab-like magnetic poles.

### CITATION LIST

### Patent Literature

Patent Literature 1: Japanese Unexamined Patent Application Publication No. 2014-143858

### BRIEF SUMMARY

The brushless motor described in Patent Literature 1 is, for example, a three-phase (U-phase, V-phase, and W-phase) brushless motor including three Hall ICs at intervals of 120 degrees in the rotation direction of the rotational shaft.

An example of a known brushless motor is a slotless brushless motor including no coil slots. The slotless brushless motor includes no core with slots. Such a brushless motor includes a cylindrical coil surrounding a rotational shaft.

The cylindrical coil has multiple phases. Wires for each phase are attached to one another to form a cylindrical shape. However, the wires are attached at deviating positions and involve many work hours to be aligned with Hall ICs. This reduces workability in manufacturing and joining the motor.

One or more aspects of the present invention are directed to a technique for increasing workability in manufacturing and joining motors.

A method for manufacturing a motor according to one embodiment is a method for manufacturing a motor including a rotational shaft, a magnet surrounding the rotational shaft, a coil being cylindrical, surrounding the rotational shaft, and including wires being wound, and a motor case being cylindrical and accommodating the magnet and the coil. The coil has a plurality of phases. The wires each corresponding to one of the plurality of phases are shifted from one another in a rotation direction of the rotational shaft. The wires include a first wire for a first phase of the plurality of phases and a second wire for a second phase of the plurality of phases adjacent to the first phase in the rotation direction. The first wire is colored differently from the second wire. The coil has a color boundary between the wires for the first phase and the second phase adjacent to each other in the rotation direction. The method includes aligning the color boundary with a mark in the motor case to fix the coil to the motor case.

A method for joining a motor according to one embodiment is a method for joining a motor to a gear case in a fixed manner. The motor includes a rotational shaft, a plurality of magnets surrounding the rotational shaft to rotate with the rotational shaft, a coil surrounding the rotational shaft and including wires being wound, and a motor case being cylindrical and accommodating the plurality of magnets and the coil. The coil has a plurality of phases. The gear case includes a substrate on which a plurality of sensors are mounted to detect positions of the plurality of magnets. The method includes aligning the coil in the rotation direction with the plurality of sensors to fix the motor case to the gear case using a position adjuster included in the gear case or the motor case.

The methods according to the above aspects of the present invention increase workability in manufacturing and joining motors.

### BRIEF DESCRIPTION OF DRAWINGS

FIG. 1 is an external perspective view of a brushless motor.

FIG. 2 is a cross-sectional view of the brushless motor in FIG. 1.

FIG. 3 is a perspective view of a coil included in the brushless motor in FIG. 1.

FIG. 4 is a top view of the coil received in a motor case in assembling the brushless motor in FIG. 1.

FIG. 5 is a rear view of magnets in the brushless motor in FIG. 1 and Hall ICs on a flexible substrate, showing the positional relationship between the magnets and the Hall ICs.

FIG. 6 is a perspective view of the brushless motor in FIG. 1, showing screw fastening holes in the motor case.

FIG. 7 is a rear view of the brushless motor in FIG. 1 joined to a gear case.

FIG. 8 is a plan view of the screw fastening holes in the motor case of the brushless motor in FIG. 1 aligned with elongated holes in the gear case.

FIG. 9 is a perspective view of the brushless motor in FIG. 1, showing three pairs of screw fastening holes in a motor case.

FIG. 10 is a rear view of the brushless motor with the motor case in FIG. 9 joined to the gear case (without misalignment).

FIG. 11 is a partial rear view of the brushless motor with the motor case in FIG. 9 joined to the gear case (with misalignment).

FIG. 12 is a plan view of the brushless motor with the motor case in FIG. 9 joined to the gear case (with misalignment).

### DETAILED DESCRIPTION

One embodiment of the present invention will now be described in detail with reference to the drawings. In the drawings used to describe the embodiment, the same reference numerals denote the same or substantially the same components or elements. The components or elements described once will not basically be described repeatedly. Unless otherwise specified, the terms such as first and second will be used simply to distinguish the components and will not represent a specific order or sequence.

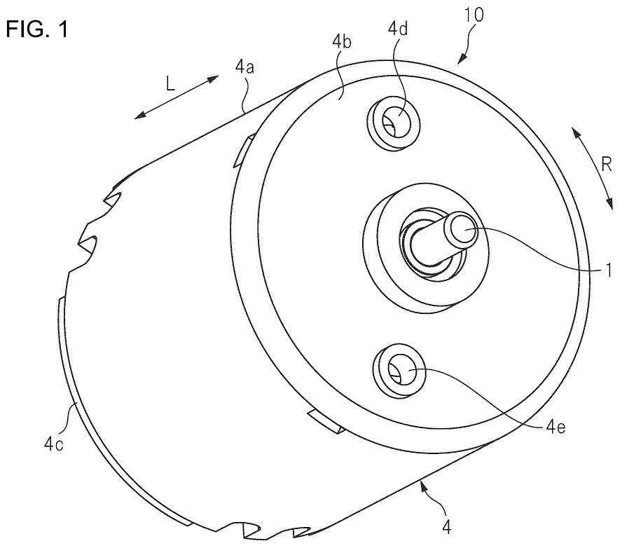

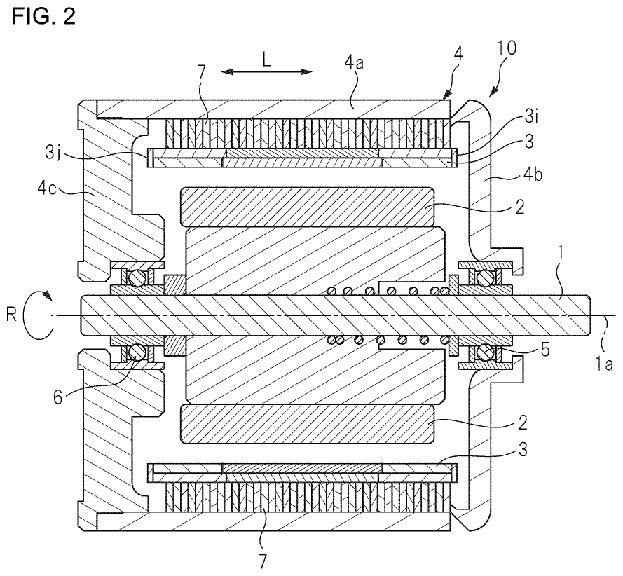

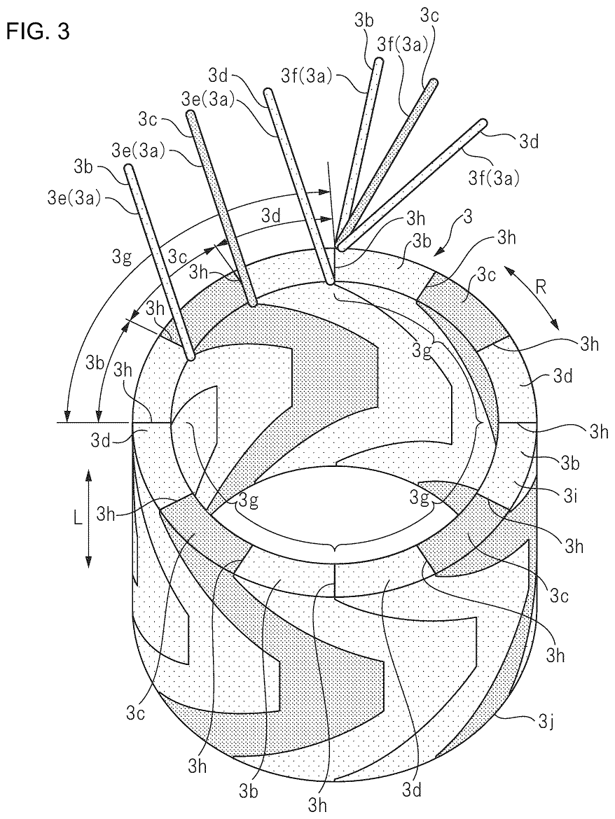

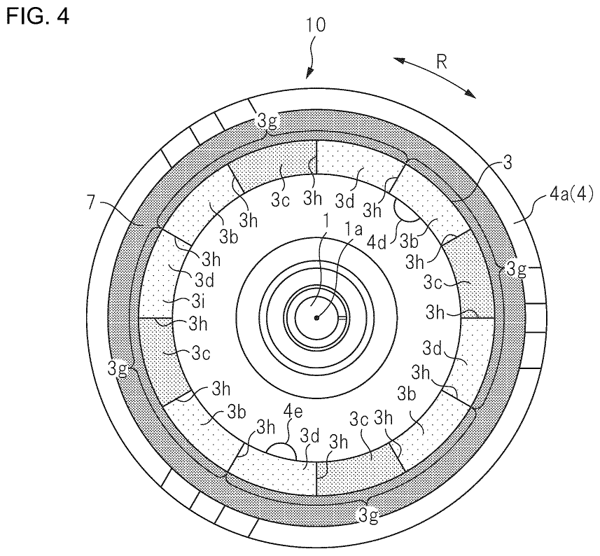

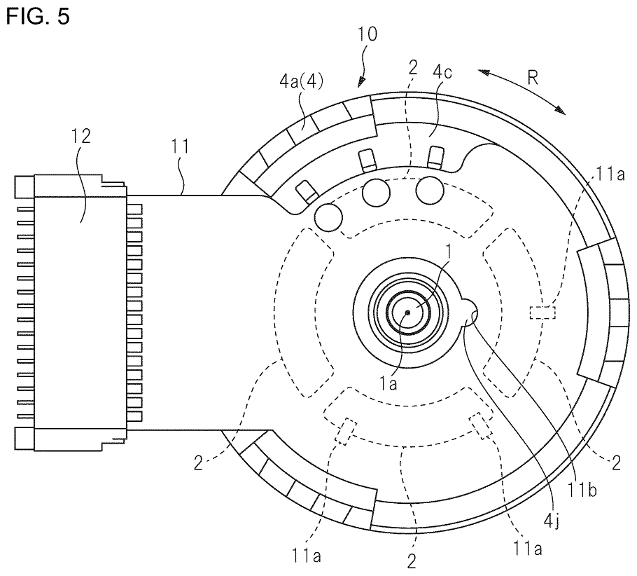

FIG. 1 is an external perspective view of a brushless motor according to the present embodiment. FIG. 2 is a cross-sectional view of the brushless motor according to the present embodiment. FIG. 3 is a perspective view of a coil included in the brushless motor. FIG. 4 is a top view of the coil received in a motor case in assembling the brushless motor according to the present embodiment. FIG. 5 is a plan view of magnets in the brushless motor according to the present embodiment and Hall-effect integrated circuits (Hall ICs) on a flexible substrate, showing the positional relationship between the magnets and the Hall ICs.

### Structure of Brushless Motor

A brushless motor 10 according to the present embodiment is used for any purposes. The brushless motor 10 is used for, for example, driving joints of a robot and rotates a gear included in a module.

The brushless motor 10 is a slotless brushless motor, which includes no slots for receiving windings. In other words, the brushless motor 10 includes no core with slots for receiving windings. The brushless motor 10 thus includes a cylindrical coil 3 surrounding a rotational shaft 1. As shown in FIGS. 1 to 5, the brushless motor 10 includes the rotational shaft 1, magnets 2 surrounding the rotational shaft 1, the cylindrical coil 3 being wound wires 3a and surrounding the rotational shaft 1, and a cylindrical motor case 4 accommodating the magnets 2 and the coil 3. In this structure, each magnet 2 is a rotor rotatable with the rotational shaft 1. The cylindrical coil 3 surrounding the rotational shaft 1 and the magnets 2 is a stator that is fixed and non-rotatable.

As shown in FIG. 5, four arc-shaped magnets 2 are located annularly to surround the rotational shaft 1 at intervals. As shown in FIGS. 1 and 2, part of the rotational shaft 1, the four magnets 2, the cylindrical coil 3, and a laminate steel sheet 7 located outward from the cylindrical coil 3 are accommodated in the cylindrical motor case 4. The cylindrical coil 3 is located outward from the four annularly-located magnets 2. In some embodiments, the cylindrical coil 3 may be arranged on the circumference of a circle centered at a rotational center 1a of the rotational shaft 1.

The motor case 4 includes a cylindrical body 4a, a disk-shaped top surface lid 4b on the top surface of the cylindrical body 4a, and a disk-shaped bottom surface lid 4c on the bottom surface of the cylindrical body 4a. The rotational shaft 1 thus has one end supported rotatably by a bearing 5 at the center of the top surface lid 4b and the other end supported rotatably by a bearing 6 at the center of the bottom surface lid 4c.

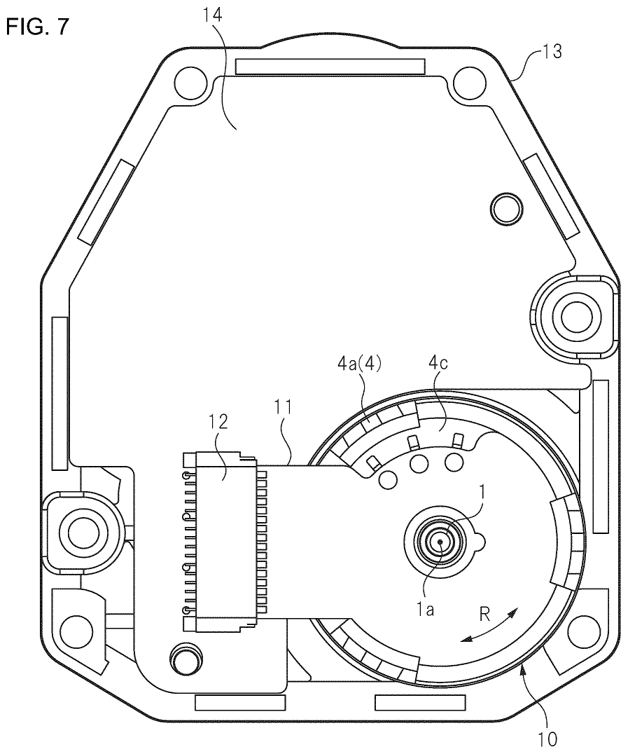

As shown in FIG. 1, the top surface lid 4b of the motor case 4 has screw fastening holes 4d and 4e used for fixing the brushless motor 10 to a gear case 13 shown in FIG. 7 (described later).

The brushless motor 10 according to the present embodiment is a three-phase motor. As shown in FIG. 3, the cylindrical coil 3 has three phases, or a U phase 3b, a W phase 3c, and a V phase 3d. In the coil 3, the wires 3a each corresponding to one of the phases extend in the direction along the rotational shaft 1 as shown in FIG. 2 (hereafter also referred to as an extending direction L of the rotational shaft 1) and are shifted from one another in a rotation direction R of the rotational shaft 1. More specifically, the wires 3a extend in the extending direction L of the rotational shaft 1 while bending in a V shape from one end 3i and extend in the rotation direction R at the other end 3j. The wires 3a are then reversed to extend in the extending direction L of the rotational shaft 1 toward the end 3i while bending in a V shape again. Thus, the wires 3a corresponding to the three phases are shifted from one another in the rotation direction R for each phase.

In this structure, a set of wires 3a for the U phase 3b, a set of wires 3a for the W phase 3c, and a set of wires 3a for the V phase 3d shifted from one another in the rotation direction R are arranged over 360 degrees. In other words, multiple wire groups 3g, each including wires 3a corresponding to the three phases, or the U phase 3b, the W phase 3c, and the V phase 3d, are shifted from one another over 360 degrees in the rotation direction R. For the coil 3 shown in FIG. 3, four wire groups 3g, each including the wires 3a for the U phase 3b, the W phase 3c, and the V phase 3d, are shifted over 360 degrees in the rotation direction R.

Each of the wires 3a corresponding to one of the phases has a winding start end 3e and a winding finish end 3f. More specifically, the wire 3a for the U phase 3b has the winding start end 3e and the winding finish end 3f for the U phase 3b. The wire 3a for the W phase 3c has the winding start end 3e and the winding finish end 3f for the W phase 3c. The wire 3a for the V phase 3d has the winding start end 3e and the winding finish end 3f for the V phase 3d. The winding start end 3e for each phase is located on the corresponding set of wires 3a and near a boundary 3h between the corresponding phase and the adjacent phase in the rotation direction R. The winding finish ends 3f for the three phases are collected at an end of one wire group 3g.

For the coil 3 in the present embodiment, wires 3a, among the wires 3a for the three phases, for adjacent phases in the rotation direction R are colored differently. In other words, the three phases have adjacent phases in the rotation direction R formed with wires 3a colored differently. More specifically, in each wire group 3g, a wire 3a for the phase in the middle of the three phases shifted from one another in the rotation direction R is colored differently from wires 3a for the phases at the two ends of the three phases. Still more specifically, in each wire group 3g, a wire 3a for the W phase 3c located in the middle of the U phase 3b, the W phase 3c, and the V phase 3d shifted from one another in the rotation direction R is colored differently from wires 3a for the phases at the two ends, or the U phase 3b and the V phase 3d.

The coil 3 thus has color boundaries 3h each between the corresponding wires 3a for phases adjacent to each other in the rotation direction R. More specifically, in each wire group 3g, the coil 3 has, on its ends 3i and 3j, the color boundaries 3h each between the corresponding wires 3a for phases adjacent to each other in the rotation direction R. The coil 3 shown in FIG. 3 has twelve boundaries 3h along its circumference of each of the ends 3i and 3j.

### Features of Brushless Motor

As shown in FIG. 5, the brushless motor 10 includes three Hall ICs (sensors) 11a to detect the positions of rotors that are the magnets 2. Each Hall IC 11a is a sensor including a magnetic detector element. For the three-phase brushless motor 10, the Hall ICs 11a are located at, for example, intervals of 120 degrees in the rotation direction R of the rotational shaft 1. Any displacement of the Hall ICs 11a can greatly reduce the efficiency of the motor or cause abnormal rotation of the motor.

The Hall ICs (sensors) 11a are thus to be positioned as designed. The three Hall ICs 11a at designed positions detect the N poles or the S poles of the magnets 2. The driver circuit of the motor then determines, based on the result of the detection, the wire 3a for the phase of the coil 3 to which a current is fed. A current is then fed sequentially to the wires 3a each for one of the phases in response to a signal from the motor driver circuit, causing the motor to rotate normally. In other words, the Hall ICs 11a are to be positioned appropriately in the brushless motor 10.

The brushless motor 10 according to the present embodiment includes the three Hall ICs 11a on a flexible substrate 11, as shown in FIG. 5. The flexible substrate 11 is positioned relative to the motor case 4 with a recess 11b on the flexible substrate 11 fitted to a protrusion 4j on the bottom surface lid 4c of the motor case 4 of the brushless motor 10. This positions the cylindrical motor case 4 in the rotation direction R.

The brushless motor 10 includes the four arc-shaped magnets 2 located annularly about the rotational shaft 1 at equal intervals. The magnets 2 serve as part of the rotor. The cylindrical coil 3 is located outward from the four annularly located arc-shaped magnets 2. The coil 3 serves as part of the stator. As shown in FIG. 3, the cylindrical coil 3 includes the four wire groups 3g shifted over 360 degrees in the rotation direction R. The four wire groups 3g each include the wires 3a corresponding to the three phases, or the U phase 3b, the W phase 3c, and the V phase 3d.

For the brushless motor 10 to maintain its efficiency and normal rotation, the cylindrical coil 3 is to be positioned appropriately relative to the cylindrical motor case 4 in the rotation direction R, as well as relative to the three Hall ICs 11a.

### Method for Manufacturing Brushless Motor

To position the cylindrical coil 3 in the rotation direction R when assembling the brushless motor 10 according to the present embodiment, the coil 3 is aligned with the motor case 4 in the rotation direction R before the coil 3 is attached to the motor case 4 in a fixed manner.

The brushless motor 10 includes the coil 3 that is cylindrical and the motor case 4 that is also cylindrical. As shown in FIG. 4, the cylindrical motor case 4 accommodates the cylindrical coil 3, which is fixed with an adhesive.

When the flexible substrate 11 is attached to the gear case 13 shown in FIG. 7 (described later), a pre-positioned connector 12 positions the flexible substrate 11. Further, the flexible substrate 11 is positioned relative to the motor case 4 by the recess 11b on the flexible substrate 11 and the protrusion 4j on the bottom surface lid 4c of the motor case 4. The cylindrical motor case 4 is thus positioned in the rotation direction R. The three Hall ICs 11a on the flexible substrate 11 are thus positioned automatically relative to the cylindrical motor case 4. Thus, when the cylindrical coil 3 is attached to the cylindrical motor case 4, the coil 3 is to be accurately positioned relative to the motor case 4 in the rotation direction R.

As shown in FIG. 4, the color boundaries 3h on the end 3i of the coil 3 between the wires 3a each corresponding to one of the phases are aligned with predetermined marks in the motor case 4. The coil 3 is then fixed to the motor case 4 with an adhesive. In the present embodiment described below, the screw fastening holes 4d and 4e in the motor case 4 are used as examples of the predetermined marks in the motor case 4.

More specifically, the color boundaries 3h on the end 3i of the coil 3 between the wires 3a each corresponding to one of the phases are aligned with the screw fastening holes 4d and 4e in the motor case 4 to position the cylindrical coil 3 relative to the cylindrical motor case 4 in the rotation direction R. As described above, the color boundaries 3h on the coil 3 between the wires 3a each corresponding to one of the phases are aligned with the holes 4d and 4e in the motor case 4 in the rotation direction R before the coil 3 is fixed to the motor case 4. In this state, the motor case 4 and the flexible substrate 11 are positioned relative to each other by the recess 11b on the flexible substrate 11 and the protrusion 4j on the bottom surface lid 4c of the motor case 4. This automatically determines the positional relationship between the screw fastening holes 4d and 4e in the motor case 4 and the three Hall ICs 11a on the flexible substrate 11.

In the present embodiment, the position of the phase corresponding to the winding finish end 3f of each wire 3a of the coil 3 can be readily identified with the differently colored wires 3a, as shown in FIG. 3. The coil 3 is positioned in the rotation direction R to place the three Hall ICs at, for example, the color boundaries 3h between the wires 3a of the coil 3. The coil 3 at the position in the rotation direction R is then fixed to the motor case 4.

In this structure, the coil 3 is less likely to be misaligned with the Hall ICs 11a in assembling the brushless motor 10. More specifically, when the coil 3 is attached to the motor case 4, the coil 3 having readily-identifiable color boundaries 3h between the wires 3a can be easily positioned in the rotation direction R and is less likely to be misaligned in the rotation direction R in assembling the brushless motor 10. The Hall ICs 11a and the coil 3 can thus be positioned accurately.

### Joining Brushless Motor

Joining the brushless motor 10 to the gear case 13 (refer to FIG. 7) will now be described. The flexible substrate 11, on which the three Hall ICs 11a are mounted as shown in FIG. 5, is attached to the gear case 13 with the connector 12. The three Hall ICs 11a are sensors that detect magnetic flux (the N pole or the S pole) from the magnets 2 to identify the positions of the magnets 2. As shown in FIG. 7, the connector 12 is attached to a circuit board 14 on the rear surface of the gear case 13. The circuit board 14 includes, for example, a driver circuit for driving a brushless motor.

The coil 3 is aligned in the rotation direction R with the three Hall ICs 11a, and the motor case 4 of the brushless motor 10 is fixed to the gear case 13 using a position adjuster included in the gear case 13.

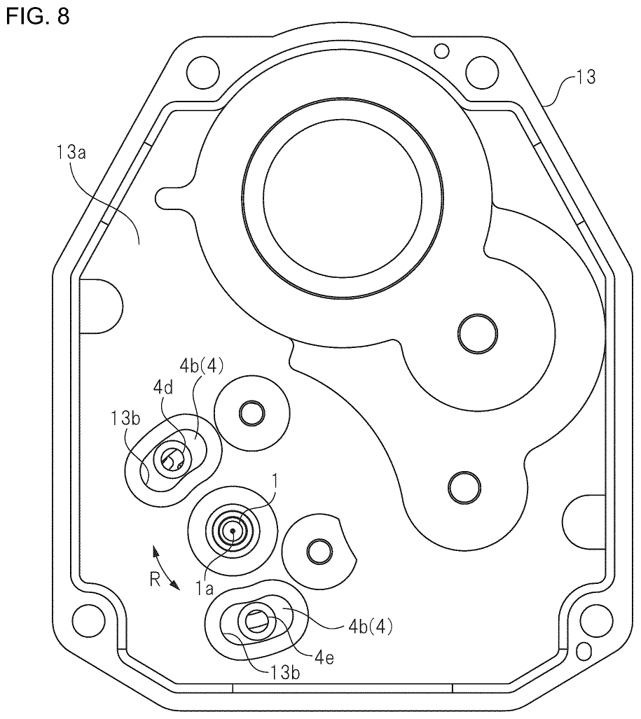

Examples of the position adjuster include two elongated holes 13b in the gear case 13, as shown in FIG. 8. The two elongated holes 13b are on a top surface lid 13a of the gear case 13 and located on the circumference of a circle centered at the rotational center 1a of the rotational shaft 1.

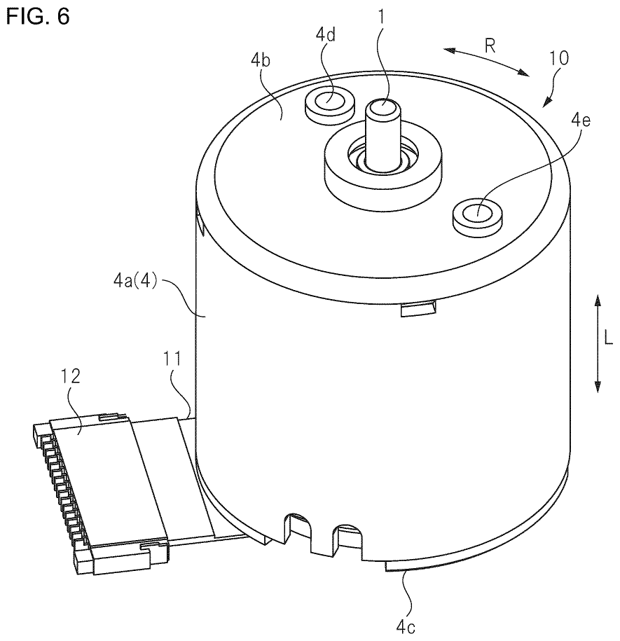

As shown in FIG. 6, the top surface lid 4b of the motor case 4 of the brushless motor 10 has the two screw fastening holes 4d and 4e arranged on the circumference of a circle centered at the rotational center 1a of the rotational shaft 1.

This allows the two holes 4d and 4e in the motor case 4 to be aligned with the two elongated holes 13b in the gear case 13, as shown in FIG. 8. More specifically, one elongated hole 13b is aligned with the hole 4d, and the other elongated hole 13b is aligned with the hole 4e. The elongated holes 13b in the gear case 13 facilitate alignment of the holes 4d and 4e in the motor case 4 with the elongated holes 13b in the gear case 13. In other words, the elongated holes 13b in the gear case 13 can accommodate any misalignment of the motor case 4 in the rotation direction R when the motor case 4 is attached to the gear case 13. The motor case 4 and the gear case 13 can thus be aligned easily, facilitating fixing of the motor case 4 to the gear case 13 with screws.

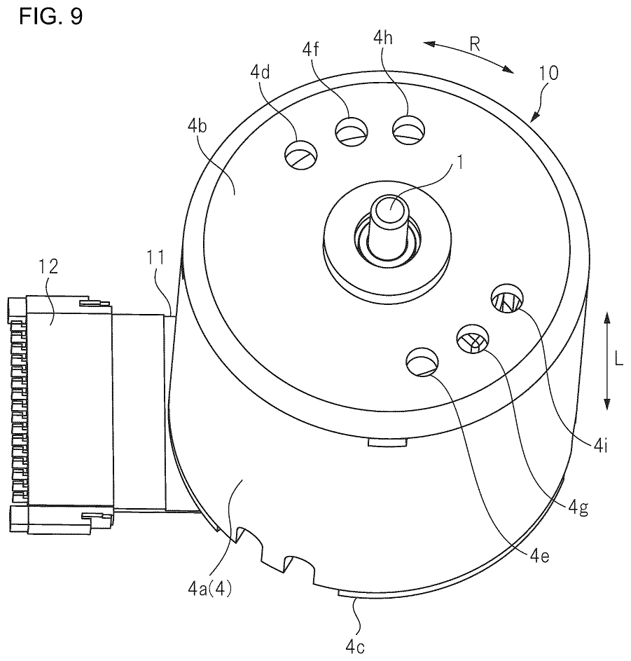

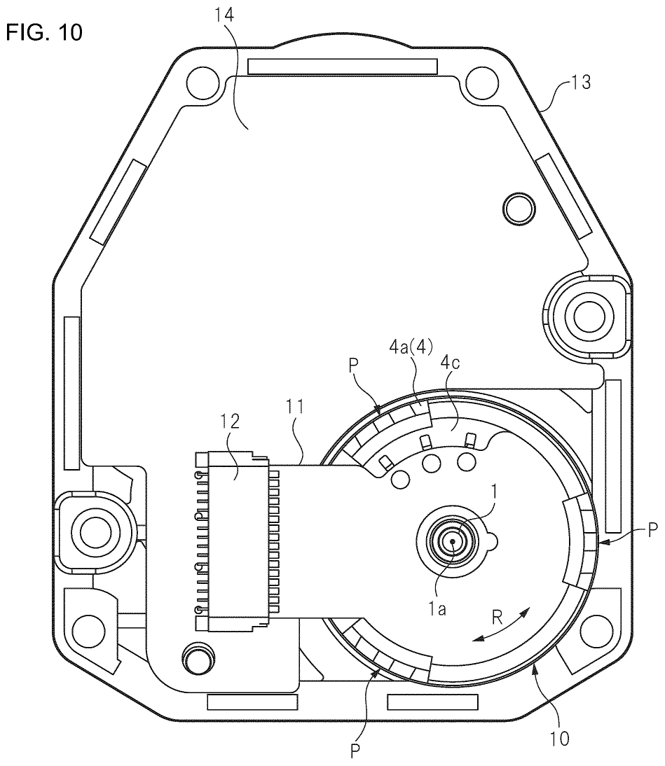

Examples of the position adjuster also include six holes (first holes) 4d, 4e, 4f, 4g, 4h, and 4i in the motor case 4, as shown in FIG. 9. The six holes 4d, 4e, 4f, 4g, 4h, and 4i are located on the top surface lid 4b of the motor case 4 to surround the rotational shaft 1, or more specifically, arranged on the circumference of a circle centered at the rotational center 1a of the rotational shaft 1, as shown in FIG. 10.

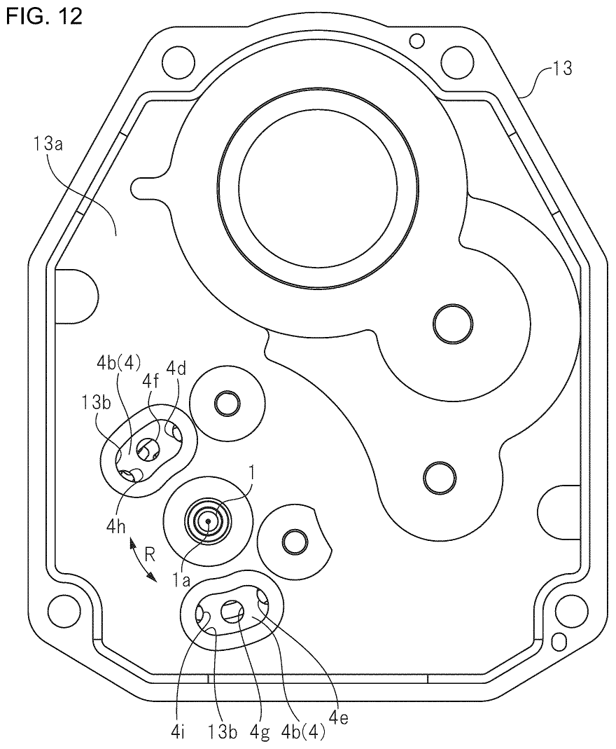

As shown in FIG. 12, the gear case 13 has the two elongated holes (second holes) 13b as screw fastening holes on the top surface lid 13a. The two elongated holes 13b are arranged on the circumference of a circle centered at the rotational center 1a of the rotational shaft 1.

The two elongated holes 13b in the gear case 13 are thus aligned with any two of the six holes 4d, 4e, 4f, 4g, 4h, and 4i in the motor case 4 to fix the motor case 4 to the gear case 13. More specifically, the motor case 4 and the gear case 13 are fixed with screws.

More specifically, the motor case 4 has the six holes 4d, 4e, 4f, 4g, 4h, and 4i arranged on the circumference of a circle centered at the rotational center 1a of the rotational shaft 1. The gear case 13 has the two elongated holes 13b arranged on the circumference of a circle centered at the rotational center 1a of the rotational shaft 1. In this structure, the two elongated holes 13b in the gear case 13 can be aligned easily with any two of the six holes 4d, 4e, 4f, 4g, 4h, and 4i in the motor case 4. Still more specifically, one elongated hole 13b in the gear case 13 is aligned with the hole 4f of the six holes 4d, 4e, 4f, 4g, 4h, and 4i in the motor case 4. The other elongated hole 13b in the gear case 13 is aligned with the hole 4g of the six holes 4d, 4e, 4f, 4g, 4h, and 4i in the motor case 4. The six holes 4d, 4e, 4f, 4g, 4h, and 4i in the motor case 4 allow any two of the holes 4d, 4e, 4f, 4g, 4h, and 4i to be easily aligned with the elongated holes 13b in the gear case 13. In other words, the six holes 4d, 4e, 4f, 4g, 4h, and 4i in the motor case 4 can accommodate any misalignment of the motor case 4 in the rotation direction R when the motor case 4 is attached to the gear case 13.

For example, FIG. 10 shows the motor case 4 fixed in an aligned manner, as shown with a P section. More specifically, the brushless motor 10 is attached with two of the six holes 4d, 4e, 4f, 4g, 4h, and 4i in the motor case 4 aligned with the elongated holes 13b in the gear case 13.

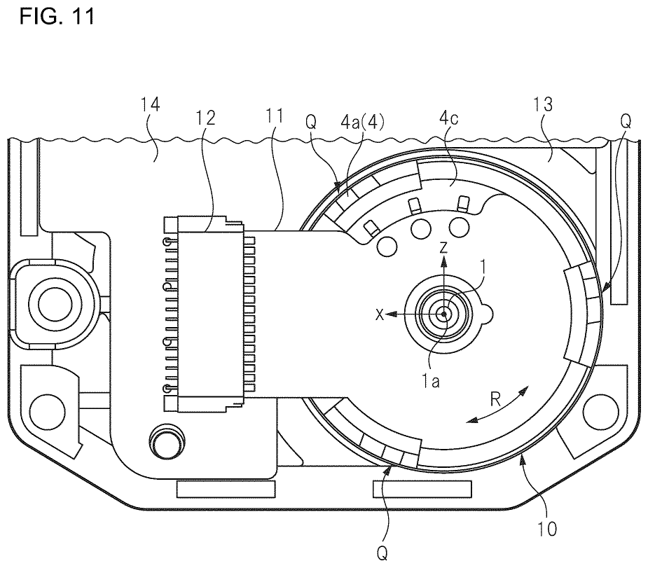

In contrast, FIG. 11 shows the motor case 4 fixed within a tolerable misalignment range in the rotation direction R, as shown with a Q section. In this case as well, the six holes 4d, 4e, 4f, 4g, 4h, and 4i in the motor case 4 allow any two of the six holes to be easily aligned with the elongated holes 13b in the gear case 13. This allows the motor case 4 to be easily fixed to the gear case 13 with screws although the motor case 4 is slightly misaligned with the gear case 13 in the rotation direction R as shown with the Q section. In other words, the brushless motor 10 can be easily joined to the gear case 13.

### Effects of Embodiment

In the brushless motor 10, the coil 3 has the color boundaries 3h each between wires 3a for phases adjacent to each other in the rotation direction R. The color boundaries 3h between the wires 3a are aligned with the holes 4d and 4e (marks) in the motor case 4 to fix the coil 3 to the motor case 4. In this structure, the phases of the coil 3 formed with the wires 3a colored differently for the phases can be easily identifiable. In particular, a wire 3a for the phase in the middle (W phase 3c) of the three phases in one wire group 3g is colored differently from wires 3a for the phases at the two ends. In this structure, the position of the W phase 3c on the coil 3 relative to the holes (marks) 4d and 4e in the motor case 4 can be readily identified. The coil 3 can thus be positioned easily in the rotation direction R relative to the motor case 4.

The above structure also facilitates alignment of the coil 3 with the Hall ICs 11a in the rotation direction R. The brushless motor 10 can thus be manufactured with higher workability. The coil 3, which can be easily positioned relative to the motor case 4 in the rotation direction R, can be stably positioned in the rotation direction R for attachment. This facilitates alignment of the motor case 4 with the flexible substrate 11, thus reducing deviation of the brushless motor 10 and the flexible substrate 11 from each other in joining.

In other words, when the coil 3 is attached to the motor case 4, the coil 3 can be positioned relative to the holes 4d and 4e in the motor case 4 in the rotation direction R. Thus, the position of the coil 3 in the rotation direction R is less likely to be adjusted when the coil 3 is attached to the motor case 4. More specifically, the coil 3 positioned in the rotation direction R for attachment to the motor case 4 can minimize the position adjustment of the coil in the rotation direction R for attachment. This increases workability in manufacturing the brushless motor 10.

Further, a wire 3a for the phase in the middle of the three phases in one wire group 3g is colored differently from wires 3a for the phases at the two ends. In this structure, the wire 3a having the winding finish end 3f at the W phase 3c on the coil 3 is readily identified. The wire 3a to be reversed is thus easily identified, reducing errors in connecting common wires. This reduces work hours in identifying wires 3a for connecting common wires.

When the brushless motor 10 is joined to the gear case 13, the elongated holes 13b as the screw fastening holes in the gear case 13 allow the holes 4d and 4e in the motor case 4 to be aligned with the elongated holes 13b in the gear case 13, although the flexible substrate 11 is joined at a deviating position in the rotation direction R. The motor case 4 and the gear case 13 can thus be fixed easily with screws, increasing workability in joining the brushless motor 10.

For the brushless motor 10 to be joined to the gear case 13, the motor case 4 has the multiple holes (e.g., 4d, 4e, 4f, 4g, 4h, and 4i) arranged on the circumference of a circle centered at the rotational center 1a of the rotational shaft 1, and the gear case 13 has the two elongated holes 13b arranged on the circumference of a circle centered at the rotational center 1a of the rotational shaft 1. This allows any two of the multiple holes in the motor case 4 to be easily aligned with the elongated holes 13b in the gear case 13. In the same manner as described above, the motor case 4 and the gear case 13 can thus be fixed easily with screws, thus increasing workability in joining the brushless motor 10.

A method for manufacturing the brushless motor 10 and a method for joining the brushless motor 10 according to one embodiment has been described above, but the present invention is not limited to the above embodiment. Other forms implementable within the scope of technical idea of the present invention fall within the scope of the present invention.

In the above embodiment, for joining the brushless motor 10 to the gear case 13, the motor case 4 has the six holes 4d, 4e, 4f, 4g, 4h, and 4i, but may have any number of holes more than two, such as eight holes.

The gear case 13 may have any holes other than the elongated holes (position adjusters or second holes) 13b, such as circular holes.

The technique according to one or more embodiments of the present invention may provide the structure described below.

(1) A method for manufacturing a motor including a rotational shaft, a magnet surrounding the rotational shaft, a coil being cylindrical, surrounding the rotational shaft, and including wires being wound, and a motor case being cylindrical and accommodating the magnet and the coil, the coil having a plurality of phases, the wires each corresponding to one of the plurality of phases being shifted from one another in a rotation direction of the rotational shaft, the wires including a first wire for a first phase of the plurality of phases and a second wire for a second phase of the plurality of phases adjacent to the first phase in the rotation direction, the first wire being colored differently from the second wire, the coil having a color boundary between the wires for the first phase and the second phase adjacent to each other in the rotation direction, the method comprising:
aligning the color boundary with a mark in the motor case to fix the coil to the motor case.

(2) The method according to (1), wherein
the mark is a hole in the motor case, and
the aligning includes aligning the color boundary with the hole in the rotation direction to fix the coil to the motor case.

(3) The method according to (1) or (2), wherein
the motor has three phases, and
the wires corresponding to the three phases shifted from one another in the rotation direction of the rotational shaft form a wire group, the wires in the wire group include a wire for a phase in a middle of the three phases and wires for phases at two ends of the three phases, and the wire for the phase in the middle is colored differently from the wires for the phases at the two ends.

(4) The method according to (3), wherein
the wires for the three phases shifted in the rotational direction of the rotational shaft are colored differently.

(5) A method for joining a motor to a gear case in a fixed manner, the motor including a rotational shaft, a plurality of magnets surrounding the rotational shaft to rotate with the rotational shaft, a coil surrounding the rotational shaft and including wires being wound, and a motor case being cylindrical and accommodating the plurality of magnets and the coil, the coil having a plurality of phases, the gear case including a substrate on which a plurality of sensors are mounted to detect positions of the plurality of magnets, the method comprising:
aligning the coil in the rotation direction with the plurality of sensors to fix the motor case to the gear case using a position adjuster included in the gear case or the motor case.

(6) The method according to (5), wherein
the position adjuster includes a plurality of elongated holes in the gear case,
the plurality of elongated holes are arranged on a circumference of a circle centered at a rotational center of the rotational shaft,
the motor case includes a plurality of holes,
the plurality of holes are arranged on a circumference of a circle centered at the rotational center of the rotational shaft, and
the aligning includes aligning the plurality of holes in the motor case with the plurality of elongated holes in the gear case to fix the motor case to the gear case.

(7) The method according to (5), wherein
the position adjuster includes a plurality of first holes in the motor case,
the plurality of first holes are arranged on a circumference of a circle centered at a rotational center of the rotational shaft,
the gear case includes a plurality of second holes,
the plurality of second holes are arranged on a circumference of a circle centered at the rotational center of the rotational shaft, and
the aligning includes aligning first holes of the plurality of first holes in the motor case with the plurality of second holes in the gear case to fix the motor case to the gear case.

What is claimed is:

1. A method for manufacturing a motor including a rotational shaft, a magnet surrounding the rotational shaft, a coil being cylindrical, surrounding the rotational shaft, and including wires being wound, and a motor case being cylindrical and accommodating the magnet and the coil, the coil having a plurality of phases, the wires each corresponding to one of the plurality of phases being shifted from one another in a rotation direction of the rotational shaft, the wires including a first wire for a first phase of the plurality of phases and a second wire for a second phase of the plurality of phases adjacent to the first phase in the rotation direction, the first wire being colored differently from the second wire, the coil having a color boundary between the wires for the first phase and the second phase adjacent to each other in the rotation direction, the method comprising:
aligning the color boundary with a mark in the motor case to fix the coil to the motor case.

2. The method according to claim 1, wherein
the mark is a hole in the motor case, and
the aligning includes aligning the color boundary with the hole in the rotation direction to fix the coil to the motor case.

3. The method according to claim 1, wherein
the motor has three phases, and
the wires corresponding to the three phases shifted from one another in the rotation direction of the rotational shaft form a wire group, the wires in the wire group include a wire for a phase in a middle of the three phases and wires for phases at two ends of the three phases, and the wire for the phase in the middle is colored differently from the wires for the phases at the two ends.

4. A method for joining a motor to a gear case in a fixed manner, the motor including a rotational shaft, a plurality of magnets surrounding the rotational shaft to rotate with the rotational shaft, a coil surrounding the rotational shaft and including wires being wound, and a motor case being cylindrical and accommodating the plurality of magnets and the coil, the coil having a plurality of phases, the gear case including a substrate on which a plurality of sensors are mounted to detect positions of the plurality of magnets, the method comprising:
aligning the coil in the rotation direction with the plurality of sensors to fix the motor case to the gear case using a position adjuster included in the gear case or the motor case.

5. The method according to claim 4, wherein
the position adjuster includes a plurality of elongated holes in the gear case,
the plurality of elongated holes are arranged on a circumference of a circle centered at a rotational center of the rotational shaft,
the motor case includes a plurality of holes,
the plurality of holes are arranged on a circumference of a circle centered at the rotational center of the rotational shaft, and
the aligning includes aligning the plurality of holes in the motor case with the plurality of elongated holes in the gear case to fix the motor case to the gear case.

6. The method according to claim 4, wherein
the position adjuster includes a plurality of first holes in the motor case,
the plurality of first holes are arranged on a circumference of a circle centered at a rotational center of the rotational shaft,
the gear case includes a plurality of second holes,
the plurality of second holes are arranged on a circumference of a circle centered at the rotational center of the rotational shaft, and
the aligning includes aligning first holes of the plurality of first holes in the motor case with the plurality of second holes in the gear case to fix the motor case to the gear case.
